(19) United States
(12) Patent Application Publication
(10) Pub. No.: US 2013/0031619 A1
(43) Pub. Date: Jan. 31, 2013

(54) REMOTE AUTHENTICATION SCREEN LOCKER FOR A MOBILE DEVICE

(71) Applicants: Rod D. Waltermann, Rougemont, NC (US); David Rivera, Durham, NC (US)

(72) Inventors: Rod D. Waltermann, Rougemont, NC (US); David Rivera, Durham, NC (US)

(73) Assignee: Lenovo (Singapore) Pte. Ltd., Singapore (SG)

(21) Appl. No.: 13/189,869

(22) Filed: Jul. 25, 2011

(51) Int. Cl. H04L 9/32

(52) U.S. Cl. 726/8

(57) ABSTRACT

Devices, methods and products are described that provide for remote authentication of mobile information handling devices. One aspect provides a method comprising configuring an information handling device operating through a mobile operating system to allow communication with least one remote authentication architecture; denying access to a information handling device of the information handling device responsive to a device lock event; and granting access to the display device responsive to an unlock event comprising entry of logon credentials authenticated at the at least one remote authentication architecture. Other embodiments and aspects are also described herein.

### BACKGROUND

Advances in mobile computing technology have lead business enterprises and other organizations to increasingly rely on mobile computing devices as part of their operating technology. In addition, users are taking advantage of improved product designs to increase the amount of information, especially personal and confidential information, accessed through their mobile computing devices. Many of these devices, such as cell phones, personal digital assistants (PDAs), and tablet computers, are secured primarily through local screen locking methods. For example, a typical smart phone may be configured to lock the device screen after a certain period of inactivity and to unlock the screen in response to a user entering a numeric pin or gesturing a specific pattern. Local screen locking methods, however, provide inadequate means for enterprises to manage mobile computing device users and their access to network resources and data.

### BRIEF SUMMARY

In summary, one aspect provides an information handling device comprising: one or more processors; a display device accessible by the one or more processors; a memory in operative connection with the one or more processors; wherein, responsive to execution of program instructions accessible to the one or more processors operating through a mobile operating system, the one or more processors are configured to: allow communication with at least one remote authentication architecture; deny access to the information handling device responsive to a device lock event; and grant access to the information handling device responsive to an unlock event comprising entry of logon credentials authenticated at the at least one remote authentication architecture.

Another aspect provides a method comprising: configuring an information handling device operating through a mobile operating system to allow communication with least one remote authentication architecture; denying access to a information handling device of the information handling device responsive to a device lock event; and granting access to the display device responsive to an unlock event comprising entry of logon credentials authenticated at the at least one remote authentication architecture.

A further aspect provides a program product comprising: a storage medium having program code embodied therewith, the program code comprising: program code configured to allow communication between an information handling device operating through a mobile operating system and at least one remote authentication architecture; program code configured to deny access to the information handling device of the information handling device responsive to a device lock event; and program code configured to grant access to the information handling device responsive to an unlock event comprising entry of logon credentials authenticated at the at least one remote authentication architecture.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example mobile information handling device configured according to an embodiment.

FIG. 2 provides an example device access security configuration menu according to an embodiment.

FIG. 3 provides an example flow diagram of a particular embodiment.

FIG. 4 illustrates an example circuitry of an information handling device.

FIG. 5 illustrates another example circuitry of an information handling device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail to avoid obfuscation.

Enterprises are now incorporating a wide array of mobile information handling and communication devices into their operating technology. In addition to traditional PC workstations and laptop computers, devices such as cell phones, personal digital assistants (PDAs), and tablet computing devices are now considered essential tools for employees when performing day-to-day functions. In addition, many organizations are now granting such devices greater access to network resources and information.

The increased use of mobile information handling and communication devices has many advantages, including flexibility in the type of devices available to employees and more efficient access to company information from remote locations. However, enhanced reliance on such devices also poses new challenges for enterprises and their IT departments. Device security is a primary concern because it is severely limited according to existing technology. For example, current cell phone technology mainly provides for local screen lock functions to prevent unauthorized use of a particular device. Information handling devices running mobile operating systems provide configurable screen lock functions that lock the device screen after a certain period of inactivity and unlock the screen in response to some form of unlock event. Exemplary mobile operating systems include the Android®, Blackberry®, Windows Phone 7®, iOS® operating systems, and any other operating system capable of operating a mobile information handling device. Android® is a trademark of Google Inc. in the United States and other countries. Blackberry® is a registered trademark of Research In Motion Limited. Windows® and Windows Phone 7® are registered trademarks of Microsoft Corporation. iOS® is a registered trademark of Cisco in the United States and other countries.

Screen lock functions may provide sufficient security at the personal level; however, they are inadequate at the enterprise level. IT departments require security measures that allow them to manage devices, users, and access to network resources and information. Screen lock functions provide inadequate IT manageability because they offer limited security settings and policies, if they offer them at all, and they do not allow for centralized management of device access. For example, screen lock functions do not provide a means for IT personnel to change, expire, or recall a screen lock password should an employee be terminated or leave the company, nor do they provide a means of selectively controlling device access to resources or data.

A primary structure used by IT departments to administer security is Windows® Active Directory®. Active Directory® is a registered trademark of Microsoft Corporation in the United States, other countries, or both. Active Directory® is a directory service configured for Microsoft network operating systems, which provides infrastructure for administering network services, such as the assignment of network security policies. Access to Active Directory® and related objects are managed through Lightweight Directory Access Protocol (LDAP), a protocol designed to manage access to directory structures. Active Directory® and LDAP provide for the centralized management of user authentication in a Windows® server environment. This architecture allows IT departments to remotely administer user privileges on devices seeking access to the network.

Embodiments provide for remotely securing a mobile information handling device through enterprise authentication methods. According to embodiments, device security functions used to locally secure mobile information handling devices may be expanded to handle remote authentication. For example, embodiments may be configured to allow a user to unlock a device using enterprise network logon credentials. Non-limiting examples of remote authentication include, but are not limited to, user authentication provided through a network authentication server (e.g., Windows®, Linux®, and the like), network security devices, network architecture supporting LDAP, Windows® network operating system supporting Active Directory®, or a combination thereof. Linux® is a registered trademark of Linus Torvalds. Accordingly, embodiments allow security policies to be configured at a central network architecture and employed on a mobile information handling device by executing remote authentication of device users at the central network architecture.

An illustrative and non-restrictive example of a mobile information handling device is a cell phone, or “smartphone”, powered by the Android® operating system. The Android operating system as currently configured may securely lock a device screen after a specified period of inactivity and provides the following three means for thereafter unlocking the screen: a numeric pin, a local alphanumeric password, and a gesture pattern, such as a swipe pattern or selection pattern. In addition, other methods for unlocking a device may be utilized, including, but not limited to, facial recognition and biometric input. However, the screen lock functionality provided through the Android® operating system does not allow for remote authentication, such as authentication through a server configured to administer network security. Accordingly, embodiments provide for expanding the available methods for securely locking and unlocking a mobile information handling device, such as a smartphone powered by the Android® operating system. According to embodiments, a method for integrating screen lock functionality with remote authentication may be added to the available means for locking and unlocking a device.

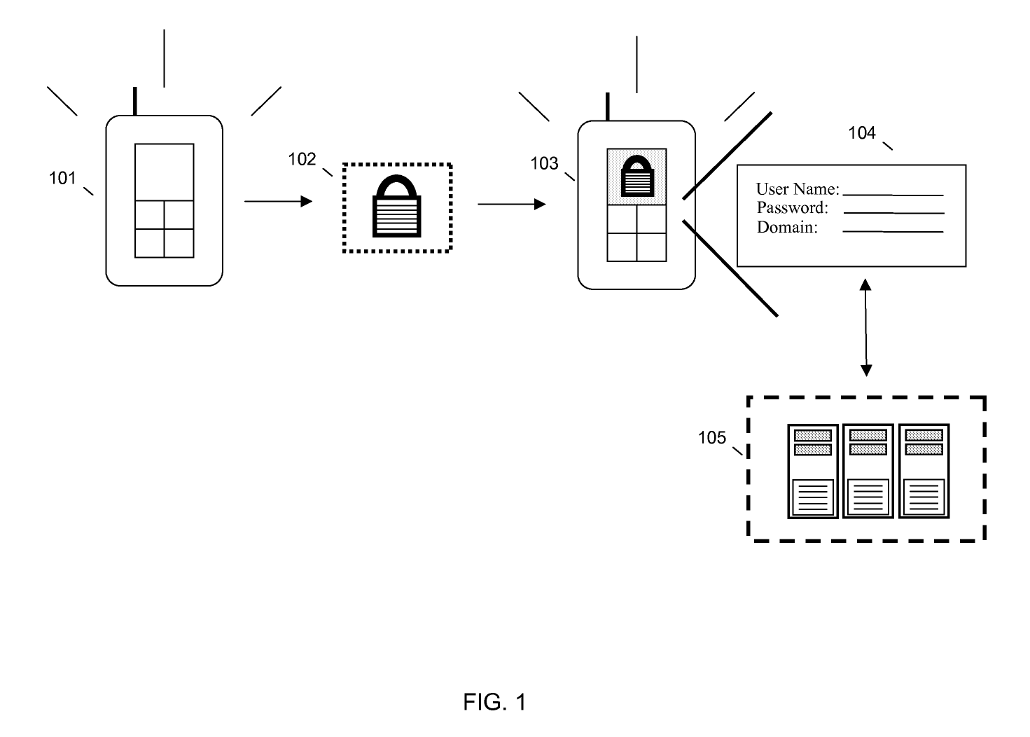

Referring to FIG. 1, therein is depicted an example mobile information handling device configured according to an embodiment. The mobile information handling device provided in FIG. 1 is a smartphone 101 configured to lock the screen in response to a screen lock event 102. Non-limiting examples of screen lock events 102 include expiration of a configurable timeout period (e.g., thirty seconds, one minute, etc.) or through explicit device lock functions (e.g., pressing a screen lock button, logging out of the device, performing a specified screen lock gesture). When a user attempts to use the device in the locked state 103, he is prompted with an unlock method 104 configured at the remote authentication server 105. In the example depicted in FIG. 1, the unlock method 104 comprises entering a user name and password configured through a remote authentication server 105.

Through the configuration of mobile information handling devices to unlock a device screen through remote authentication, embodiments allow an enterprise to set security policies on managed devices. Illustrative and non-restrictive examples of security policies include setting the strength and duration of passwords, expiring or locking user accounts, configuring device user privileges, and granting or denying access to resources and data. For example, an IT administrator may set the status of a user in the remote authentication system to “expired” such that when the user attempts to unlock the mobile device screen, entry of his user name and password no longer unlocks the device because his access to the mobile device has been effectively deactivated.

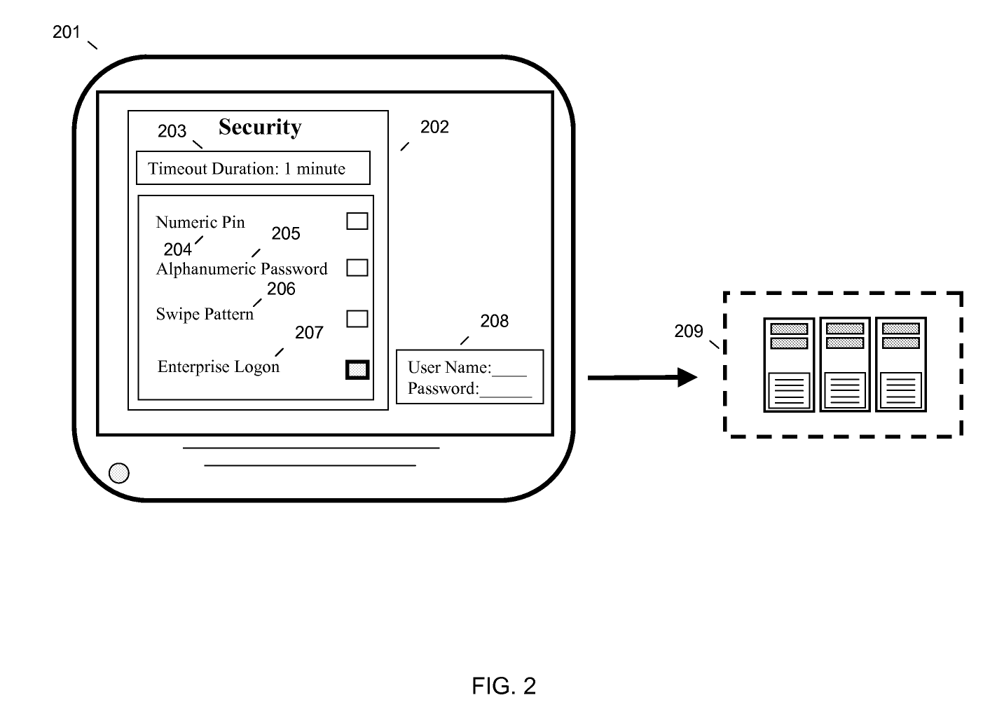

An example menu for configuring security for a device configured according to an embodiment is provided in FIG. 2. A mobile information handling device in the form of a tablet information handling device 201 comprises a menu 202 for configuring access security for the device 201. The menu 202 provides settings to lock the device, including a setting for a timeout duration 203, and selections for how to unlock the device, including the methods of numeric pin 204, local alphanumeric password 205, swipe pattern 206, and enterprise logon 207. Selection of the enterprise logon 207 evokes a request for enterprise logon credentials 208. The user may enter credentials that are authenticated against security policies configured at the back end security infrastructure 209.

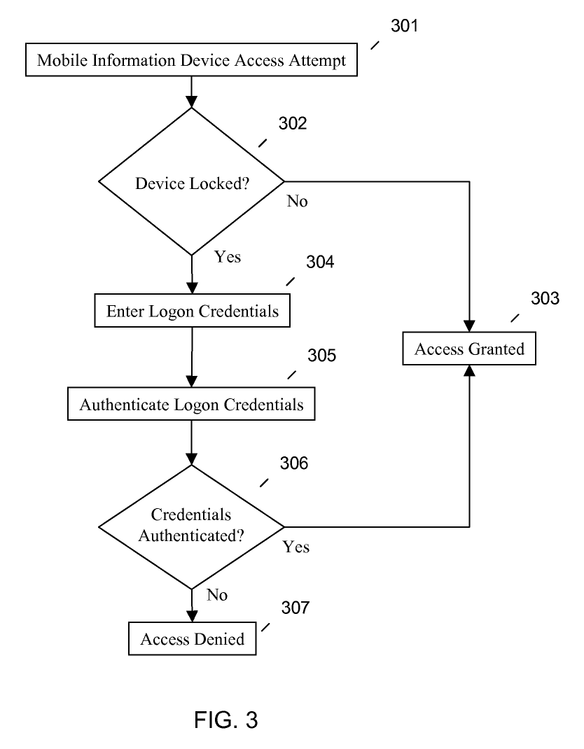

Referring to FIG. 3, therein is provided a flow diagram of an example embodiment. A user attempts to access a mobile information handling device 301 and the device determines whether it is in a locked or unlocked mode 302. If the device is not locked, access to the device is granted 303. If the device is locked, the user is prompted to enter enterprise logon credentials 304. The credentials are authenticated at the enterprise security architecture 305. If the user is authenticated 306, access to the device is granted 303; otherwise, access is denied 307.

A version of the enterprise logon credentials may be stored locally according to embodiments. As a non-limiting example, a user name and a hashed version of an associated password may be stored locally so that a user may access the device when not in communication with the authenticating domain. As such, embodiments provide for a setting wherein the local cached password may be used to unlock the device. As a non-limiting example, if the device cannot communicate with the authentication domain, the local cached credentials may be used. In addition, embodiments may also provide a setting that expires the local cached password after a specific event, such as a certain number of logins or the expiration of a time period. Thus, a device configured according to embodiments may require that users connect to the enterprise network after a certain period of using local cached logon credentials.

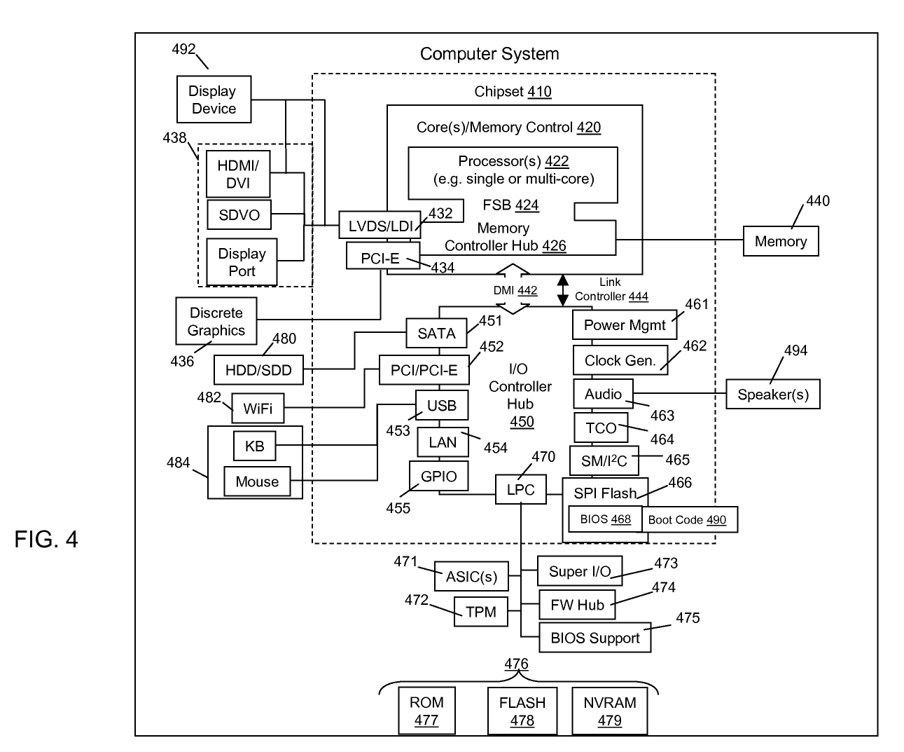

While various other circuits, circuitry or components may be utilized, FIG. 4 depicts a block diagram of one example of information handling device circuits, circuitry or components. The example depicted in FIG. 4 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 4.

The example of FIG. 4 includes a so-called chipset 410 (a group of integrated circuits, or chips, that work together, chipsets) with an architecture that may vary depending on manufacturer (for example, INTEL, AMD, ARM, etc.). The architecture of the chipset 410 includes a core and memory control group 420 and an I/O controller hub 450 that exchanges information (for example, data, signals, commands, et cetera) via a direct management interface (DMI) 442 or a link controller 444. In FIG. 4, the DMI 442 is a chip-to-chip interface (sometimes referred to as being a link between a “northbridge” and a “southbridge”). The core and memory control group 420 include one or more processors 422 (for example, single or multi-core) and a memory controller hub 426 that exchange information via a front side bus (FSB) 424; noting that components of the group 420 may be integrated in a chip that supplants the conventional “northbridge” style architecture.

In FIG. 4, the memory controller hub 426 interfaces with memory 440 (for example, to provide support for a type of RAM that may be referred to as “system memory” or “memory”). The memory controller hub 426 further includes a LVDS interface 432 for a display device 492 (for example, a CRT, a flat panel, a projector, et cetera). A block 438 includes some technologies that may be supported via the LVDS interface 432 (for example, serial digital video, HDMI/DVI, display port). The memory controller hub 426 also includes a PCI-express interface (PCI-E) 434 that may support discrete graphics 436.

In FIG. 4, the I/O hub controller 450 includes a SATA interface 451 (for example, for HDDs, SDDs, 480 et cetera), a PCI-E interface 452 (for example, for wireless connections 482), a USB interface 453 (for example, for input devices 484 such as a digitizer, keyboard, mice, cameras, phones, storage, other connected devices, et cetera.), a network interface 454 (for example, LAN), a GPIO interface 455, a LPC interface 470 (for ASICs 471, a TPM 472, a super I/O 473, a firmware hub 474, BIOS support 475 as well as various types of memory 476 such as ROM 477, Flash 478, and NVRAM 479), a power management interface 461, a clock generator interface 462, an audio interface 463 (for example, for speakers 494), a TCO interface 464, a system management bus interface 465, and SPI Flash 466, which can include BIOS 468 and boot code 490. The I/O hub controller 450 may include gigabit Ethernet support.

The system, upon power on, may be configured to execute boot code 490 for the BIOS 468, as stored within the SPI Flash 466, and thereafter processes data under the control of one or more operating systems and application software (for example, stored in system memory 440). An operating system may be stored in any of a variety of locations and accessed, for example, according to instructions of the BIOS 468. As described herein, a device may include fewer or more features than shown in the system of FIG. 4.

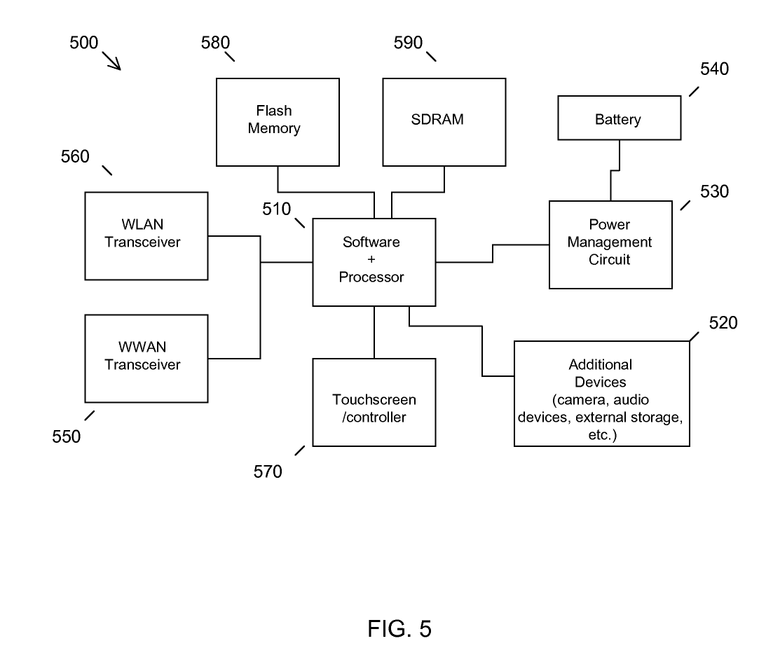

For example, referring to FIG. 5, with regard to smart phone and/or tablet circuitry 500, an example includes an ARM based system (system on a chip) design, with software and processor(s) combined in a single chip 510. Internal busses and the like depend on different vendors, but essentially all the peripheral devices (520) may attach to a single chip 510. In contrast to the circuitry illustrated in FIG. 5, the tablet circuitry 500 combines the processor, memory control, and I/O controller hub all into a single chip 510. Also, ARM based systems 500 do not typically use SATA or PCI or LPC. Common interfaces for example include SDIO and I2C. There are power management chip(s) 530, which manage power as supplied for example via a rechargeable battery 540, which may be recharged by a connection to a power source (not shown), and in the at least one design, a single chip, such as 510, is used to supply BIOS like functionality and DRAM memory.

ARM based systems 500 typically include one or more of a WWAN transceiver 550 and a WLAN transceiver 560 for connecting to various networks, such as telecommunications networks and wireless base stations. Commonly, an ARM based system 500 will include a touchscreen 570 for data input and display. ARM based systems 500 also typically include various memory devices, for example flash memory 580 and SDRAM 590.

Embodiments may be implemented in one or more information handling devices configured appropriately to execute program instructions consistent with the functionality of the embodiments as described herein. In this regard, FIGS. 4-5 illustrate non-limiting examples of such devices and components thereof. While mobile computing systems such as tablet computers, laptop computers, and smart phones have been specifically mentioned as examples herein, embodiments may be implemented using other systems or devices as appropriate.

As will be appreciated by one skilled in the art, various aspects may be embodied as a system, method or computer (device) program product. Accordingly, aspects may take the form of an entirely hardware embodiment or an embodiment including software that may all generally be referred to herein as a “circuit,” “module” or “system.” Furthermore, aspects may take the form of a computer (device) program product embodied in one or more computer (device) readable medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An information handling device comprising:
one or more processors;
a display device accessible by the one or more processors;
a memory in operative connection with the one or more processors;
wherein, responsive to execution of program instructions accessible to the one or more processors operating through a mobile operating system, the one or more processors are configured to:
allow communication with at least one remote authentication architecture;
deny access to the information handling device responsive to a device lock event; and
grant access to the information handling device responsive to an unlock event comprising entry of logon credentials authenticated at the at least one remote authentication architecture.

2. The information handling device of claim 1, wherein the information handling device comprises a cell phone.

3. The information handling device of claim 1, wherein a lock event comprises expiration of a lockout time period.

4. The information handling device of claim 1, wherein the remote logon credentials are cached locally on the information handling device.

5. The information handling device of claim 4, wherein access to the information handling device is allowed through entry of the cached remote logon credentials responsive to the information handling device being unable to communicate with the at least one remote authentication architecture.

6. The information handling device of claim 1, wherein the at least one remote authentication architecture authenticates logon credentials through lightweight directory access protocol (LDAP).

7. The information handling device of claim 1, wherein at least one security policy associated with the remote logon credentials is configured at the at least one remote authentication architecture.

8. The information handling device of claim 1, wherein the unlock event further comprises entry of a numeric pin and entry of an alphanumeric password.

9. The information handling device of claim 8, wherein the unlock event further comprises entry of a gesture pattern.

10. A method comprising:
configuring an information handling device operating through a mobile operating system to allow communication with least one remote authentication architecture;
denying access to a information handling device of the information handling device responsive to a device lock event; and
granting access to the display device responsive to an unlock event comprising entry of logon credentials authenticated at the at least one remote authentication architecture.

11. The method of claim 10, wherein the information handling device comprises a cell phone.

12. The method of claim 10, wherein the remote logon credentials are cached locally on the information handling device.

13. The method of claim 12, wherein access to the information handling device is allowed through entry of the cached remote logon credentials responsive to the information handling device being unable to communicate with the at least one remote authentication architecture.

14. The method of claim 10, wherein at least one security policy associated with the remote logon credentials is configured at the at least one remote authentication architecture.

15. The method of claim 10, wherein the at least one remote authentication architecture authenticates logon credentials through lightweight directory access protocol (LDAP).

16. The method of claim 10, wherein the unlock event further comprises entry of a numeric pin and entry of an alphanumeric password.

17. The method of claim 16, wherein the unlock event further comprises entry of a gesture pattern.

18. A program product comprising:
a storage medium having program code embodied therewith, the program code comprising:
program code configured to allow communication between an information handling device operating through a mobile operating system and at least one remote authentication architecture;
program code configured to deny access to the information handling device of the information handling device responsive to a device lock event; and
program code configured to grant access to the information handling device responsive to an unlock event comprising entry of logon credentials authenticated at the at least one remote authentication architecture.

19. The program product of claim 18, wherein the unlock event further comprises entry of a numeric pin and entry of an alphanumeric password.

20. The program product of claim 19, wherein the unlock event further comprises entry of a gesture pattern.
